(19) United States
(12) Patent Application Publication
(10) Pub. No.: US 2021/0063192 A1
(43) Pub. Date: Mar. 4, 2021

(54) OWN LOCATION ESTIMATION DEVICE

(71) Applicants: SOKEN, INC., Nisshin-city (JP); DENSO CORPORATION, Kariya-city (JP)

(72) Inventors: Shunya KUMANO, Nisshin-city (JP); Takeshi SHIKIMACHI, Kariya-city (JP)

(21) Appl. No.: 17/095,077

(22) Filed: Nov. 11, 2020

Related U.S. Application Data
(63) Continuation of application No. PCT/JP2019/011088, filed on Mar. 18, 2019.

(30) Foreign Application Priority Data
May 17, 2018 (JP) 2018-095471

(51) Int. Cl. G01C 21/36; G06K 9/00; G06T 7/13

(52) U.S. Cl. CPC G01C 21/3644; G06T 2207/30252; G06T 7/13; G06K 9/00805

(57) ABSTRACT

An own location estimation device for a vehicle having an in-vehicle camera and a cloud map server, is configured to: recognize an environment around the vehicle based on a state of the vehicle and sensing information by the in-vehicle camera; recognize a camera landmark based on the sensing information of the in-vehicle camera; update a cloud map in the map server; estimate a location of the vehicle based on the camera landmark and the map landmark in the cloud map; and generate a new landmark based on the sensing information of the in-vehicle camera when the map landmark does not exist in the cloud map, or when it is determined that an accuracy of the camera landmark is low.

### CROSS REFERENCE TO RELATED APPLICATION

The present application is a continuation application of International Patent Application No. PCT/JP2019/011088 filed on Mar. 18, 2019, which designated the U.S. and claims the benefit of priority from Japanese Patent Application No. 2018-095471 filed on May 17, 2018. The entire disclosures of all of the above applications are incorporated herein by reference.

### TECHNICAL FIELD

The present disclosure relates to an own location estimation device that estimates an own location of a traveling vehicle on a map.

### BACKGROUND

As a comparison technique, an own location estimation device, for example, is provided. The own location estimation device (AUTONOMOUS NAVIGATION BASED ON SIGNATURES) specifies the current position of the vehicle based on the change in the characteristics of the road, and determines the policy of an automatic steering operation.

### SUMMARY

An own location estimation device for a vehicle having an in-vehicle camera and a cloud map server, is configured to: recognize an environment around the vehicle based on a state of the vehicle and sensing information by the in-vehicle camera; recognize a camera landmark based on the sensing information of the in-vehicle camera; update a cloud map in the map server; estimate a location of the vehicle based on the camera landmark and the map landmark in the cloud map; and generate a new landmark based on the sensing information of the in-vehicle camera when the map landmark does not exist in the cloud map, or when it is determined that an accuracy of the camera landmark is low.

### BRIEF DESCRIPTION OF THE DRAWINGS

The above and other objects, features and advantages of the present disclosure will become more apparent from the following detailed description made with reference to the accompanying drawings. In the drawings:

FIG. 1 is an explanatory diagram showing an in-vehicle camera in an own vehicle and a cloud map server;

FIG. 2 is a plan view showing an in-vehicle camera in an own vehicle;

FIG. 3 is a block diagram showing an overall configuration of an own location estimation device;

FIG. 4 is a block diagram showing a configuration of an environment recognition unit;

FIG. 5 is a flowchart showing the overall control contents for newly generating a landmark;

FIG. 6 is a flowchart showing a control content when a new landmark (such as an intersection) of the first embodiment is generated;

FIG. 7 is an explanatory diagram showing a procedure for generating a new landmark (such as an intersection) according to the first embodiment;

FIG. 8 is a flowchart showing a control content when a new landmark (such as a tunnel) of the second embodiment is generated;

FIG. 9 is an explanatory diagram showing a procedure for generating a new landmark (such as a tunnel) according to the second embodiment; and

FIG. 10 is an explanatory diagram showing a procedure for generating a new landmark (such as a tree or a pole) according to another embodiment.

### DETAILED DESCRIPTION

In a comparison, the road width, the lane width, and the like are used as the characteristics of the road. However, in a driving scene such as an intersection on a farm road, there is a possibility that the road width cannot be correctly determined due to the effect of swaying of plants and trees in the wind, and, in some cases, the accuracy of location estimation may not be sufficiently obtained.

In view of the above point, an own location estimation device is provided to improve the accuracy of own location estimation by generating a new landmark even when road characteristics are difficult to obtain.

Based on an aspect of the present disclosure, an own location estimation device for a vehicle includes an in-vehicle camera and a cloud map server, and further includes an environment recognition unit that recognizes the surrounding environment of an own vehicle based on a state amount of the vehicle and sensing information by the in-vehicle camera. The environment recognition unit, includes: a landmark recognition unit that recognizes a camera landmark based on the sensing information of the in-vehicle camera, a cloud map transmission and reception unit that updates a cloud map in the cloud map server, and an own location estimation unit that estimates a location of an own vehicle based on the camera landmark and the map landmark in the cloud map. The landmark recognition unit includes a landmark generation unit that generates a new landmark based on the sensing information of the in-vehicle camera when the map landmark does not exist in the cloud map or when the accuracy of the camera landmark is determined to be low.

According to the above own location estimation device, when there is no map landmark in the cloud map, or when it is determined that the accuracy of the camera landmark is low, the landmark generation unit creates a new landmark based on the sensing information of the in-vehicle camera. Therefore, even if it is difficult to obtain road characteristics, it is possible to improve the accuracy of own location estimation by generating a new landmark.

According to another aspect of the present disclosure, an own location estimation device having a in-vehicle camera and a cloud map server has a processor and a memory. The processor and the memory recognize the environment around the own vehicle based on the state amount of the own vehicle and the sensing information by the in-vehicle camera, recognize the camera landmark based on the sensing information of the in-vehicle camera, update the cloud map in the map server, estimates the position of the own vehicle based on the camera landmark and the map landmark in the cloud map, and generate a new landmark based on the sensing information of the in-vehicle camera when the map landmark does not exist in the cloud map, or when it is determined that the accuracy of the camera landmark is low.

According to the above own location estimation device, when there is no map landmark in the cloud map, or when it is determined that the accuracy of the camera landmark is low, the landmark generation unit creates a new landmark based on the sensing information of the in-vehicle camera. Therefore, even if it is difficult to obtain road characteristics, it is possible to improve the accuracy of own location estimation by generating a new landmark.

The following describes a plurality of embodiments for carrying out the present disclosure with reference to the drawings. In each embodiment, portions corresponding to the elements described in the preceding embodiments are denoted by the same reference numerals, and redundant explanation may be omitted. When only a part of a configuration is described in an embodiment, another preceding embodiment may be applied to the other parts of the configuration. It may be possible not only to combine parts the combination of which is explicitly described in an embodiment, but also to combine parts of respective embodiments the combination of which is not explicitly described if any obstacle does not especially occur in combining the parts of the respective embodiments.

### First Embodiment

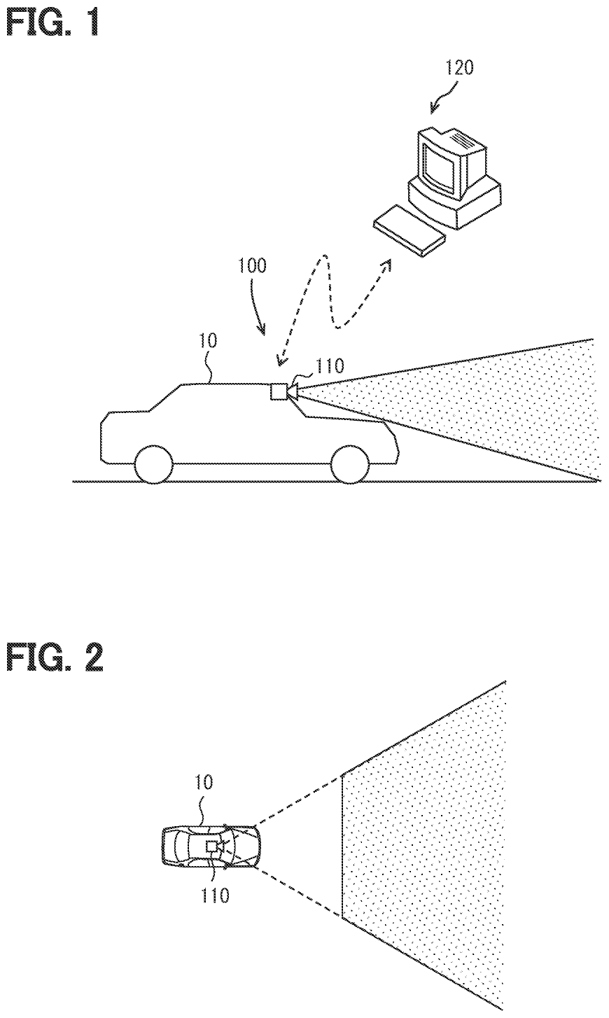

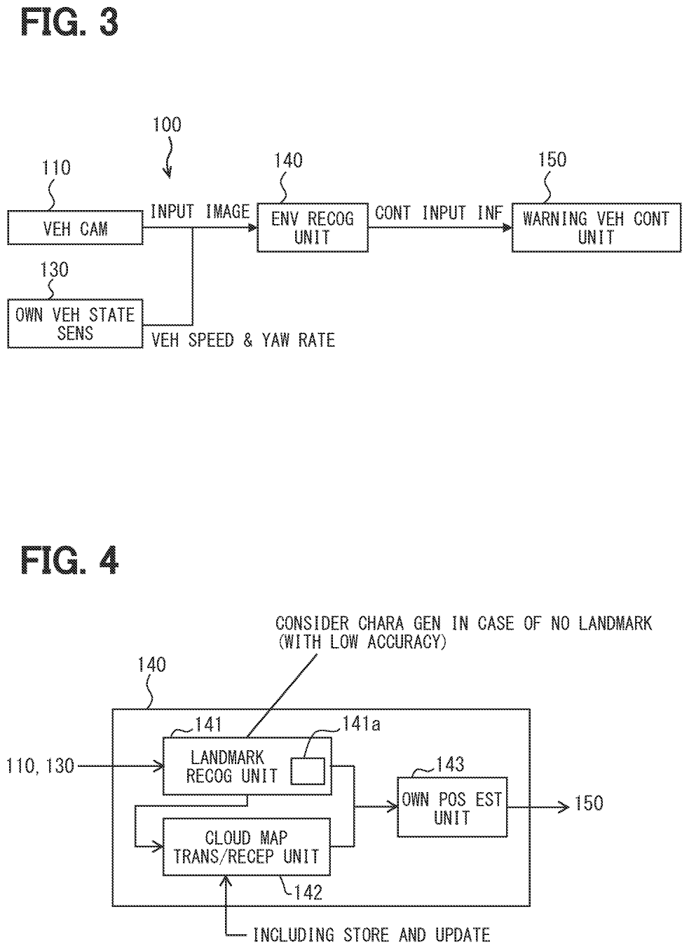

The own location estimation device 100 of the first embodiment will be described with reference to FIGS. 1 to 7. The own location estimation device 100 is mounted in, for example, a vehicle provided with a navigation system or a vehicle having an autonomous driving function. The own location estimation device 100 compares (i.e., checks) the target object detected by the in-vehicle camera 110 with the landmark on the cloud map in the cloud map server 120 while the vehicle 10 is actually traveling, and estimates which position (i.e., own location) on the cloud map the own vehicle 10 is traveling. By estimating the own position of the vehicle 10, it is possible to support the driver for safety driving and autonomous driving.

As shown in FIGS. 1 to 4, the own location estimation device 100 includes an in-vehicle camera 110, a cloud map server 120, a sensor unit 130, an environment recognition unit 140, an alarm/vehicle control unit 150, and the like.

The in-vehicle camera 110 is arranged, for example, in front of the car roof of the own vehicle 10 to photographs (i.e., senses) an actual environment (i.e., an object) around the own vehicle 10, and acquires an image data for recognizing or generating a landmark (hereinafter referred to as camera landmark) from the actual environment. The in-vehicle camera 110 outputs the acquired image data to the environment recognition unit 140.

The cloud map server 120 is a server formed on the cloud via the Internet and stores a cloud map (i.e., map data). The cloud map server 120 is capable of exchanging the map data with the cloud map transmission/reception unit 142 of the environment recognition unit 140, which will be described later, and updating the stored map data. The map data is, for example, segmented every 1 km, and has a maximum capacity of about 10 kb per 1 km. The map data indicates roads (and lanes) and various map landmarks (such as structures, buildings, traffic signs, traffic marks, etc.).

The sensor unit 130 detects a state quantity, such as a vehicle speed and a yaw rate, of the subject vehicle 10 while traveling, and outputs data of the detected state quantity to the environment recognition unit 140. From the state quantity data detected by the sensor unit 130, the environment recognition unit 140 recognizes, for example, that the subject vehicle 10 is traveling on a straight road, or how much curvature the subject vehicle 10 is travelling on a curved road, or the like.

The environment recognition unit 140 recognizes the environment around the vehicle 10 based on the sensing information (i.e., image data) by the in-vehicle camera 110 and the state quantity (i.e., state quantity data) of the vehicle 10 detected by the sensor unit 130. The environment recognition unit 140 has a landmark recognition unit 141, a cloud map transmission/reception unit 142, an own location estimation unit 143, and the like.

The landmark recognition unit 141 recognizes a camera landmark based on the sensing information (i.e., the image data) of the in-vehicle camera 110. The camera landmark is a characteristic road portion, a structure, a building, a traffic sign, a traffic mark, or the like, which is captured by the in-vehicle camera 110.

The cloud map transmission/reception unit 142 stores the camera landmark recognized by the landmark recognition unit 141 and updates the stored map data with respect to the cloud map server 120.

The own location estimation unit 143 estimates the position of the own vehicle 10 on the cloud map from the camera landmark recognized by the landmark recognition unit 141 and the map landmark on the cloud map. The own location estimation unit 143 outputs the estimated position data of the own vehicle 10 to the alarm/vehicle control unit 150.

The landmark recognition unit 141 is arranged with a landmark generation unit 141a. The landmark generation unit 141a generates a new landmark from the image data obtained based on the sensing information of the in-vehicle camera 110 when there is no map landmark in the cloud map, or when the map landmark and the camera landmark are compared and verified and it is determined that the recognition accuracy of the camera landmark is low (details will be described later).

The alarm/vehicle control unit 150 notifies the driver of the warning, for example, when the traveling direction deviates from the road direction based on the position data of the own vehicle 10 output from the environment recognition unit 140 (i.e., the own location estimation unit 143), or executes a control for autonomous driving to a predetermined destination.

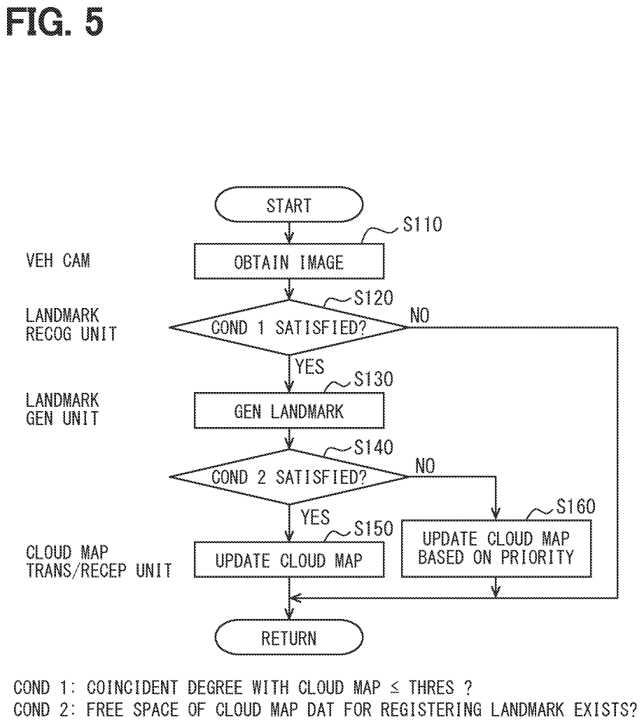

The configuration of the own location estimation device 100 is described above. Hereinafter, the operation and the effect will be described with reference to FIGS. 5 to 7. In this embodiment, the center position of the intersection is extracted as a new landmark.

In step S110 of the flowchart illustrated in FIG. 5, the in-vehicle camera 110 captures an image of a surrounding object while traveling and acquires the image data. Then, in step S120, the landmark recognition unit 141 determines whether or not the condition 1 is satisfied. The condition 1 is a condition that the degree of matching between the map landmark on the cloud map and the camera landmark based on the captured image data is equal to or less than a predetermined matching degree threshold value. When a positive decision is made in step S120, the accuracy of verification of the camera landmark with the map landmark is insufficient, so the flow moves to step S130. When a negative determination is made in step S120, the process proceeds to return.

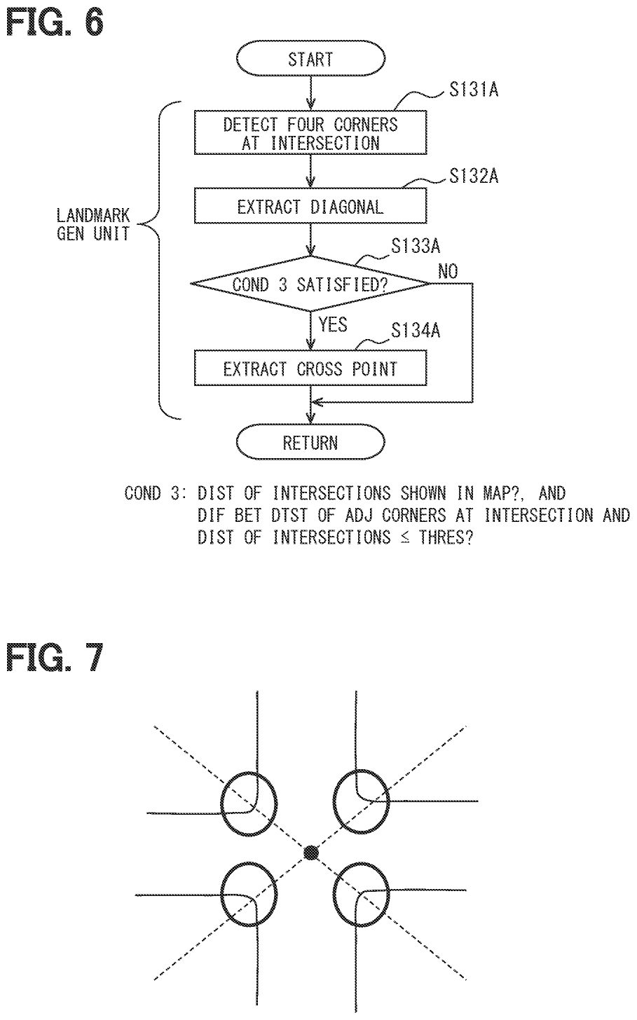

In step S130, the landmark generation unit 141a generates a new landmark. The procedure for generating a new landmark is executed based on the flowchart shown in FIG. 6.

That is, in step S131A, the landmark generation unit 141a detects four corners at the intersection, that is, four points at which the lines corresponding to the road width position intersect, as indicated by the circles in FIG. 7. Next, in step S132A, two diagonal lines (broken lines in FIG. 7) that connects the four corners diagonally are extracted. Then, in step S133A, it is determined whether the condition 3 is satisfied.

The condition 3 is such that the map data includes data of the distance between intersections, and the difference between the distance of the adjacent corners of the intersection and the distance of the intersections is equal to or less than a predetermined distance threshold. When a positive determination is made in step S133A, it is determined that the intersection imaged by the in-vehicle camera 110 matches the intersection on the map data, and the landmark generation unit 141a extracts the diagonal cross point in step S134A, and generates the center position of the intersection (i.e., the cross point) as a new landmark.

Returning to FIG. 5, in step S140, the landmark generation unit 141a determines whether or not the condition 2 is satisfied. The condition 2 is whether there is free space for registering a new landmark in the cloud map data.

When a positive determination is made in step S140, the cloud map transmission/reception unit 142 updates the cloud map in step S150. That is, a new landmark (i.e., the center position of the intersection) is registered in the cloud map.

On the other hand, when a negative determination is made in step S140, the landmark generation unit 141a determines the priority order for generating a new landmark, based on the reliability of the road feature and the object recognition obtained by the sensing information of the in-vehicle camera 110. The landmark generation unit 141a determines the priority order of generating a new landmark based on the distance from the vehicle 10, the size, and the recognition reliability.

Then, in step S160, the cloud map transmission/reception unit 142 updates the cloud map according to the priority order.

According to the above embodiment, when there is no map landmark in the cloud map, or when it is determined that the accuracy of the camera landmark is low, the landmark generation unit 141a creates a new landmark based on the sensing information of the in-vehicle camera 110. Therefore, even if it is difficult to obtain road characteristics, it is possible to improve the accuracy of own location estimation by generating a new landmark.

Further, for example, the center position of the intersection is extracted and generated as a new landmark. Thereby, a new landmark can be set easily and surely.

Further, the landmark generation unit 141a determines the priority order of generating a new landmark based on the reliability of each of the road features and the object recognition obtained by the sensing information of the in-vehicle camera 110, and also determines the priority order of the new landmark based on the distance from the host vehicle 10, the size, and the recognition reliability. This makes it possible to successively add highly reliable landmarks without unnecessarily increasing the storage capacity of the cloud map server 120.

### Second Embodiment

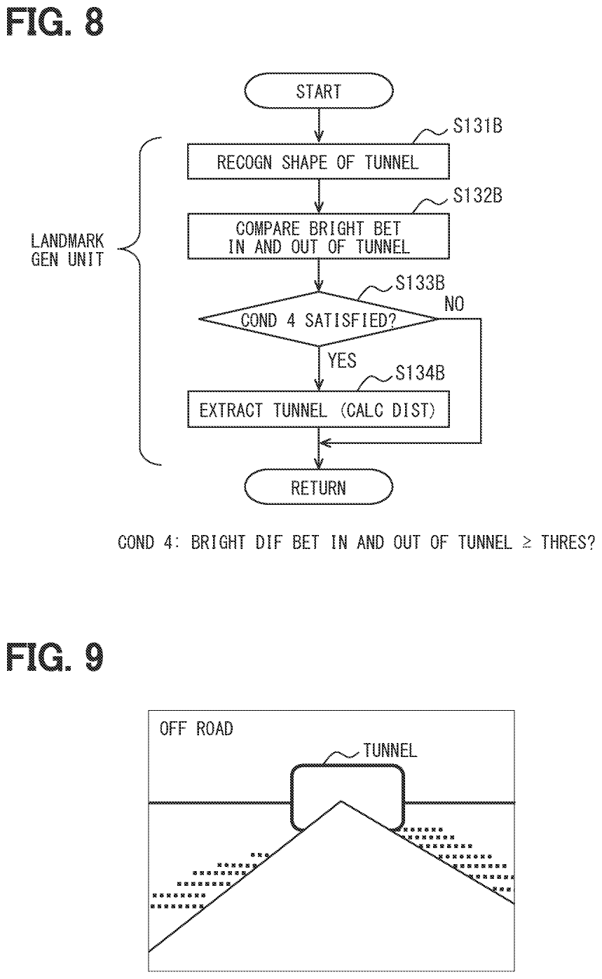

FIGS. 8 and 9 show a second embodiment. The second embodiment is different from the first embodiment in that a tunnel is used instead of an intersection as a way to generate a new landmark. In step S130 described in FIG. 5, the landmark generation unit 141a generates a new landmark in steps S131B to S134B shown in FIG. 8.

The landmark generation unit 141a generates a new landmark based on the entrance/exit position of the tunnel obtained by the sensing information of the in-vehicle camera 110. The landmark generation unit 141a calculates the entrance/exit position of the tunnel based on the entrance/exit shape of the tunnel, image brightness change, tunnel name display, and the like.

Specifically, the landmark generation unit 141a recognizes the shape of a tunnel (in FIG. 9) that is on an unpaved straight road whose road width does not change in step S131B shown in FIG. 8, and compares a brightness inside the tunnel with a brightness outside the tunnel in step S132B. Then, in step S133B, it is determined whether the condition 4 is satisfied. The condition 4 is a condition that the difference in brightness between the inside and the outside of the tunnel is equal to or larger than a predetermined brightness threshold value set in advance. When a positive determination is made in step S133B, the landmark generation unit 141a extracts the tunnel as a new landmark in step S134B.

In this embodiment, the tunnel is generated as a new landmark, and the same effect as that of the first embodiment can be obtained.

### Third Embodiment

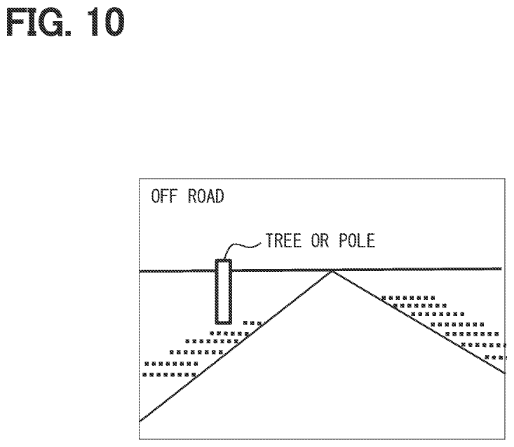

When generating a new landmark, as shown in FIG. 10, it may be generated by using a tree or a pole on the side of an unpaved road.

### Other Embodiments

In each of the above-described embodiments, an intersection, a tunnel, trees, poles, and the like have been described as examples when a new landmark is generated, but it is not limited to these, and various objects may be adopted.

The controller and the method described in the present disclosure may be implemented by a special purpose computer which is configured with a memory and a processor programmed to execute one or more particular functions embodied in computer programs of the memory. Alternatively, the controller and the method described in the present disclosure may be implemented by a special purpose computer configured as a processor with one or more special purpose hardware logic circuits. Alternatively, the control unit and the method described in the present disclosure may be implemented by one or more special purpose computer, which is configured as a combination of a processor and a memory, which are programmed to perform one or more functions, and a processor which is configured with one or more hardware logic circuits. The computer programs may be stored, as instructions to be executed by a computer, in a tangible non-transitory computer-readable medium.

Here, the process of the flowchart or the flowchart described in the present disclosure includes multiple sections (or steps), and each section is expressed as, for example, S110. Further, each section may be divided into several subsections, while several sections may be combined into one section. Furthermore, each section thus configured may be referred to as a device, module, or means.

Although the present disclosure has been described in accordance with the embodiments, it is understood that the present disclosure is not limited to such embodiments and configurations. The present disclosure covers various modification examples and equivalent arrangements. In addition, various combinations and forms, and further, other combinations and forms including only one element, or more or less than these elements are also within the scope and the scope of the present disclosure.

What is claimed is:

1. An own location estimation device for a vehicle having an in-vehicle camera and a cloud map server, the own location estimation device comprising:
an environment recognition unit that is configured to recognize an environment around the vehicle based on a state quantity of the vehicle and sensing information by the in-vehicle camera, wherein:
the environment recognition unit includes:
a landmark recognition unit that is configured to recognize a camera landmark based on the sensing information of the in-vehicle camera;
a cloud map transmission and reception unit that is configured to update a cloud map in the cloud map server; and
an own location estimation unit that is configured to estimate a location of the vehicle from the camera landmark and the map landmark in the cloud map;
the landmark recognition unit includes a landmark generation unit that is configured to generate a new landmark based on the sensing information of the in-vehicle camera when the map landmark does not exist in the cloud map or when an accuracy of the camera landmark is determined to be low; and
the landmark generation unit extracts the new landmark based on at least one corner at an intersection that are obtained by the sensing information of the in-vehicle camera.

2. The own location estimation device according to claim 1, wherein:
the landmark generation unit extracts, as the new landmark, a center position of an intersection obtained from four corners at the intersection that are obtained by the sensing information of the in-vehicle camera.

3. The own location estimation device according to claim 1, wherein:
the landmark generation unit determines a priority order of generation of the new landmark based on a reliability of a road characteristic and a reliability of object recognition obtained by sensing information of the in-vehicle camera.

4. The own location estimation device according to claim 3, wherein:
the landmark generation unit determines the priority order of generation of the new landmark based on a distance from the vehicle, a size, and the reliability of object recognition.

5. The own location estimation device according to claim 1, wherein:
the landmark generation unit generates the new landmark based on an entrance and exit position of a tunnel obtained by the sensing information of the in-vehicle camera.

6. The own location estimation device according to claim 5, wherein:
the landmark generation unit calculates a position of the entrance and exit of the tunnel based on an entrance and exit shape of the tunnel, an image brightness change, and a tunnel name display.

7. An own location estimation device for a vehicle having an in-vehicle camera and a cloud map server, the own location estimation device comprising:
a processor and a memory,
the processor and the memory are configured to:
recognize an environment around the vehicle based on a state quantity of the vehicle and sensing information by the in-vehicle camera;
recognize a camera landmark based on the sensing information of the in-vehicle camera;
update a cloud map in the cloud map server;
estimate a location of the vehicle based on the camera landmark and the map landmark in the cloud map; and
generate a new landmark based on the sensing information of the in-vehicle camera when the map landmark does not exist in the cloud map or when it is determined that an accuracy of the camera landmark is low, wherein:
the generating of the new landmark includes: extracting the new landmark based on at least one corner at an intersection that are obtained by the sensing information of the in-vehicle camera.
